(19) United States
(12) Patent Application Publication
(10) Pub. No.: US 2012/0210796 A1
(43) Pub. Date: Aug. 23, 2012

(54) DEVICE AND METHOD FOR SPECTROSCOPICALLY DETECTING MOLECULES

(76) Inventor: Wolfgang Schade, Goslar (DE)

(21) Appl. No.: 13/392,702

(22) PCT Filed: Aug. 24, 2010
(86) PCT No.: PCT/EP10/62315

§ 371 Date: May 7, 2012

(30) Foreign Application Priority Data
Aug. 28, 2009 (DE) 102009028994.1

(51) Int. Cl. G01N 21/84

(52) U.S. Cl. 73/655

(57) ABSTRACT

A method and a device for spectroscopic detection of molecules, containing a resonance body, an apparatus for identifying a vibration of the resonance body and at least one laser light source, the laser light of which interacts with the molecules to be detected and which is designed to emit light pulses with a duration of less than 200 fs, the device also containing apparatus for pulse shaping the light pulses emitted by the laser light source by modulating the amplitude and/or the phase, to generate sequentially different pulse shapes of the light pulses.

### BACKGROUND

The invention relates to a device for spectroscopic detection of molecules, containing a resonance body, an apparatus for identifying a vibration of the resonance body and at least one laser light source, the laser light of which can be made to interact with the molecules to be detected. The invention furthermore relates to a method for spectroscopic detection of molecules.

A. A. Kosterev et al.: Quartz-enhanced photoacoustic spectroscopy, Optics Letters, Vol. 27, No. 21 (2002) 1902 has disclosed a device of the type mentioned at the outset. This known detection method discloses the use of a fork-shaped quartz crystal as a highly sensitive microphone, by means of which pressure variations in a gas phase can be detected. According to the known method, the pressure variations are generated by means of a laser diode, which selectively excites the molecules in the gas phase by means of spectrally narrow-band radiation. The sensitivity of the photoacoustic measurements can be increased due to the high Q-factor of the fork-shaped quartz crystal used for the detection.

However, a disadvantage of the known method is that the detection of a multiplicity of different molecules or compounds requires a multiplicity of different laser diodes since these each can only provide a very narrow frequency band for the excitation of the molecules to be detected.

Proceeding from this prior art, the invention is therefore based on the object of providing a device and a method of the type mentioned at the outset, by means of which a plurality of different molecules can be detected in a simple fashion and within a short period of time. The invention is furthermore based on the object of increasing the sensitivity and/or the quantitative accuracy of the analysis.

### SUMMARY

According to the invention, it is proposed to use at least one resonance body and at least one apparatus for identifying at least one vibration of the resonance body for spectroscopic detection of molecules. In one embodiment of the invention, the resonance body is introduced into a gas phase that contains the molecules to be detected. The vibration of the resonance body is excited photoacoustically, i.e. by means of a pressure change in the surrounding gas phase induced by light radiation. In another embodiment of the invention, the at least one resonance body can also be used as photon impulse detector by imaging light scattered on the molecules to be detected onto the resonance body by means of a focusing or collimating optical system.

According to the invention, the use of a pulsed laser light source is proposed for exciting the molecules to be detected, which light source is able to emit light pulses with a duration of less than 200 fs. Since the spectral width of the light pulse is inversely proportional to the duration thereof, a multiplicity of wavelengths are available with decreasing pulse duration, by means of which wavelengths a multiplicity of different excitations of a molecule or else a multiplicity of different excitations in different molecules can be used for spectroscopic detection, unlike in the known method in which only a single, sharply delimited wavelength is available for exciting the molecules to be detected.

In order to enable a selectivity of the spectroscopic detection in respect of a few or a single molecule(s) to be detected, provision is furthermore made for an apparatus for pulse shaping the light pulses emitted by the laser light source. Here, the pulse shaping can be brought about, in a fashion known per se, by modulating the amplitude and/or the phase of the emitted light pulses. To this end, provision can be made for a spatial light modulator in some embodiments of the invention. This enables the light pulses emitted by the laser light source to be used for the selective excitation of individual molecules and/or individual, predeterminable excitations within a molecule, despite their increased spectral width compared to a continuous wave laser.

It is possible to change the pulse shape or the temporal substructure of the light pulses emitted by the laser light source by changing the modulation of the amplitude and/or the phase. In the process, the temporal substructure can be changed in a simple fashion and with only short switching times. To the extent that the temporal substructure of the pulses is matched to the resonant frequency of a molecular transition, the selected molecular transition can be selectively excited. This frequency typically lies in the region of a few THz (10¹² Hz). Here, the wavelength of the laser can be largely unimportant. All that is decisive in some embodiments of the invention is the temporal substructure of the pulses.

By changing the modulation of the amplitude and/or the phase, it is possible to detect a multiplicity of different molecules sequentially within a short period of time. In another embodiment of the invention, a plurality of different excitations of a molecule can be used in sequence for spectroscopic detection. This can reciprocally verify the plausibility of the measurement results obtained with different excitations in order to improve the accuracy of a quantitative detection and/or the detection limit. In some embodiments of the invention, the excitations used according to the invention for detecting the molecules can be vibrational excitations and/or rotational excitations.

According to the invention, it is possible to vary the temporal substructure of the emitted laser pulses in sequence in order thus to be able to detect different molecules in sequence. Since the detection of individual molecules only requires approximately 100 to approximately 1000 light pulses, different molecules can, in the case of high repetition rates of the utilized laser light source, be detected within a short period of time and hence virtually simultaneously in some embodiments of the invention.

In a development of the invention, provision can be made for a regulator apparatus to be used to correct a deviation of the actual shape of the light pulses from a predeterminable intended shape. This can further improve the sensitivity and accuracy of the spectroscopic detection.

In a development of the invention, provision can be made for an optical modulator or a chopper to be used additionally in order to control the time at which light pulses are emitted. This makes it possible to emit the light pulses with a predeterminable phase relation to the resonant frequency of the resonance body used to detect the measurement signal. By way of example, there may be a predeterminable ratio between the frequency of the emission of light pulses and the resonant frequency. In some embodiments of the invention, the predeterminable ratio can lie between 0.5 and 5. In one embodiment of the invention, the ratio can be approximately 1. The phase-locked coupling between the laser light source and the resonance body provides the option of recording the measurement signal from the resonance body by means of a lock-in amplifier and thereby increasing the sensitivity of the detection by suppressing the statistical background noise.

In some embodiments of the invention, the at least one apparatus for identifying a vibration of the resonance body can be designed to measure an electric voltage which a piezoelectric resonance body generates when deformed. In other embodiments of the invention, the apparatus for identifying at least one vibration of the at least one resonance body can also be embodied to detect a movement of the resonance body optically. By way of example, a measurement beam of coherent light and an interferometer can be used to this end.

In some embodiments of the invention, the optical modulator can also be made of piezoelectric material. This can make the optical modulator vibrate in a particularly simple fashion by applying an electrical signal.

In some embodiments of the invention, the optical modulator and/or the resonance body can have at least two elements, arranged approximately in parallel, which are respectively fixed to a connection element with a foot point and project freely at the end thereof opposite to the foot point. This results in the optical impression of a fork or a rake. In some embodiments, such a resonance body can simplify the spectroscopic detection of gaseous molecules if the at least two elements arranged approximately in parallel at least partly delimit the measurement space in which the molecules to be detected are situated. This enables a direct influence of the pressure variation arising when the molecules are excited on the at least two elements arranged approximately in parallel. Furthermore, this geometry enables an efficient suppression of coupled-in air sound if the length of and/or the distance between the at least two elements arranged approximately in parallel is selected to be smaller than the wavelength of the sound acting on the device.

In some embodiments of the invention, provision can be made for the molecules to be detected to emit light themselves in a characteristic fashion after being excited by at least one light pulse emitted by the laser light source. This light can be imaged on the resonance body by means of a focusing and/or collimating optical system. In this embodiment, the resonance body acts as a photon-impulse detector. As a result, the resonance body can be arranged in a common housing together with the remaining components of the device proposed according to the invention. This results in equipment that is easy to transport, the geometric capturing region of which can be set by aligning the laser light source and the optical system onto a desired target region. This embodiment of the invention can be suitable for detecting molecules which are absorbed on a surface or form the surface of a solid body themselves. Furthermore, this embodiment of the invention can be used to detect the presence and/or the concentration of molecules in a solution, if the solution has a sufficiently low absorption coefficient for the light emitted by the molecules after the laser excitation. In the process there is an interaction between the absorption coefficient and the detection limit of the measurement method such that the detection limit is moved to lower concentrations if there is a reduction in the absorption coefficient.

In one embodiment of the invention it is possible to detect molecules that are concealed behind a container wall. In this case, during a first method step, a plurality of light pulses with a duration of less than 200 fs and a predeterminable first pulse shape are used to introduce an opening in the container wall and, subsequently, to make at least a second plurality of light pulses with a predeterminable second pulse shape interact with the molecules to be detected. This allows a bore to be introduced into the container wall by means of the laser light source, through which spectroscopic detection of the molecules concealed behind the container wall can be carried out.

In some embodiments of the invention, the laser light source can introduce a bore with such a small diameter that it does not adversely affect the technical function and/or the optical appearance of the container wall. In particular, the optical appearance is to be considered not to be adversely affected if the bore cannot be perceived with the naked eye from a distance of a few 10 cm. In some embodiments of the invention, the first pulse shape can differ from the second pulse shape. In another embodiment of the invention, the first pulse shape and the second pulse shape can also be identical. Likewise, the number of light pulses contained in the first plurality of light pulses and in the second plurality of light pulses can be identical or different.

### BRIEF DESCRIPTION OF THE DRAWINGS

In the following text, the invention is intended to be explained in more detail on the basis of the figures, without this restricting the general inventive concept. In detail:

FIG. 1 shows the basic principle used for spectroscopic detection of molecules according to one embodiment of the invention.

FIG. 2 schematically shows the design of a first embodiment of the device according to the invention.

FIG. 3 schematically shows a second embodiment of the device according to the invention.

FIG. 4 illustrates the interaction between an optical modulator and a resonance body used for detecting molecules.

FIG. 5 shows a flowchart of the method proposed according to the invention.

### DESCRIPTION OF PREFERRED EMBODIMENTS

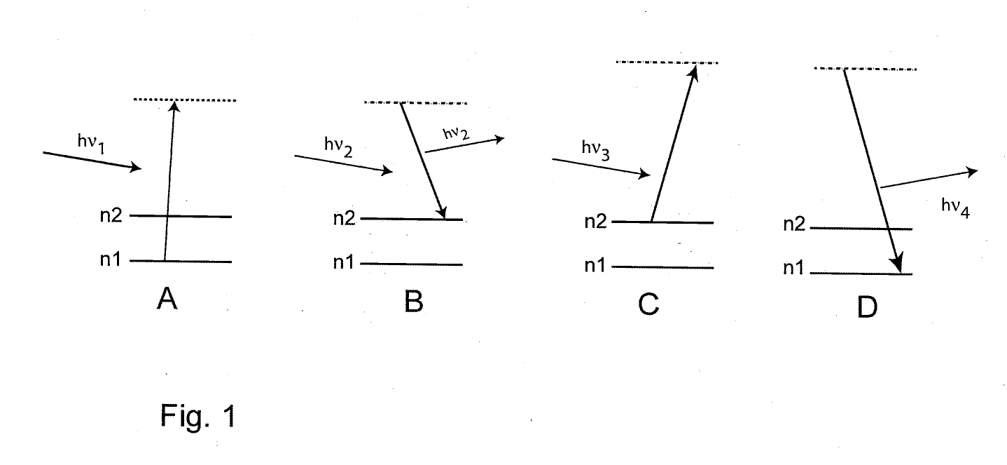

FIG. 1 illustrates the basic principle used for spectroscopic detection of molecules. Here, FIG. 1 illustrates a ground state n1 and an excited state n2. By way of example, the excited state n2 can be a vibrationally excited state and/or a rotationally excited state of a molecule. The respective occupations and the incident and/or emitted optical power at four different times A, B, C and D are illustrated.

At the start of the measurement, the molecule is in the ground state n1, as illustrated at time A. The molecule is excited into a virtual intermediate state by the incidence of at least one photon with the energy h·ν₁.

A further photon, with a frequency ν₂, impacts the molecule at time B. Here, the energy h·ν₂ of this photon corresponds to the difference between the energy h·ν₁ irradiated at the time A and the energetic spacing between states n1 and n2. At time B there is a stimulated deexcitation of the virtual state and, as a result thereof, targeted populating of the excited level n2.

A further photon with the energy h·ν₃ is absorbed at time C. The energy h·ν₃ can correspond to the energy h·ν₁. In other embodiments of the invention, the energy h·ν₃ can also be a different amount of energy from the energy h·ν₁. By absorbing the photon with the energy h·ν₃, the molecule is, starting from the excited state n2, once again excited into a virtual state.

The virtual state excited at time C falls to the ground state n1, with a photon with the frequency h·ν₄ being emitted. This photon can be deflected onto the resonance body, as proposed according to the invention, by means of a focusing and/or collimating optical system, with said resonance body as a photon impulse detector detecting the presence of the photon and hence the presence of the relevant molecule. Here the number of detected photons correlates with the number of molecules present. To the extent that no molecule with the energy levels as illustrated in FIG. 1 is present, the irradiation with photons h˜ν₁, h·ν₂ and h·ν₃ does not lead to the illustrated excitation and hence it does not lead to the emission of the photon h·ν₄ either. This can establish both a quantitative and a qualitative detection of the presence of the corresponding molecule.

In other embodiments of the invention, the state excited at time B can transition to the ground state n1 by means of a rotational-translational energy transfer. In this case, the energy supplied to the molecule by the excitation by means of the photons h·ν₁ and h·ν₂ is converted into a pressure variation that can be measured by means of the resonance body if the latter is at a distance from the excited molecule that is less than the mean free path length of the molecule.

According to the invention, the photons h·ν₁, h·ν₂ and h·ν₃ are provided by means of a single light pulse, which has obtained an appropriate pulse shape by modulation of the amplitude and/or the phase. This enables the provision of other photons with other energies within a short period of time by modulating the amplitude and/or the phase in order to use other molecules or other excitations of the same molecule for spectroscopic detection.

In one embodiment of the invention, the light pulse has a temporal width of less than 200 fs. In other embodiments of the invention, the light pulse can have a temporal width of less than 100 fs, less than 50 fs or less than 20 fs. By way of example, a light pulse with a temporal width of 20 fs exhibits a spectral bandwidth of approximately 100 nm. As a result, almost all Raman-active vibration levels n1 and n2 of different molecules can be selectively excited by appropriate pulse shaping in the case of a central wavelength of 800 nm in the near-infrared range.

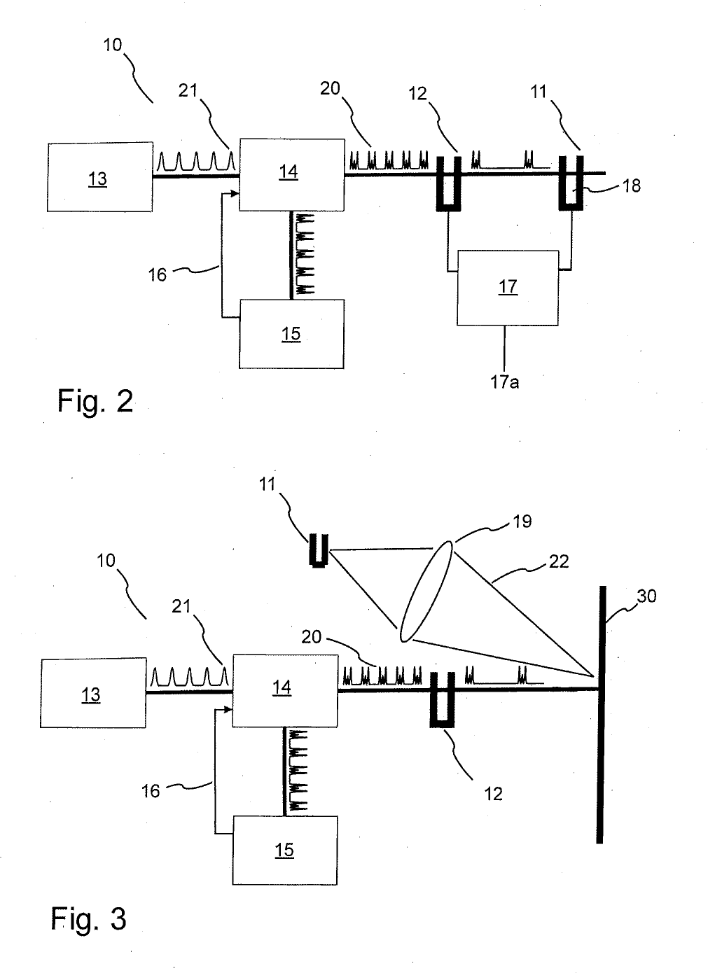

FIG. 2 schematically illustrates the design of the device according to the invention as per a first embodiment. FIG. 2 shows a laser light source 13 that emits light pulses 21 with a duration of less than 200 fs. By way of example, the light pulses 21 can have a duration of less than 200 fs, less than 100 fs, less than 50 fs or less than 20 fs. The spectral width increases as the pulse duration decreases. Thus, a pulse 21 with a duration of 20 fs can have a spectral width of 100 nm. In some embodiments of the invention, the pulse repetition rate of light pulses 21 can be 100 MHz. In other embodiments of the invention, the pulse repetition rate can be 50 MHz, 20 MHz, 10 MHz, 1 MHz or an intermediate value thereof.

The light pulses 21 are guided to an apparatus 14 for pulse shaping. In the apparatus 14, each of the supplied light pulses 21 is shaped in a manner known per se by modulation of the amplitude and/or the phase. As a result of this pulse shaping, the spectral range of the light pulses 21 is restricted to the extent that the light pulses 20 provided at the output of the apparatus 14 at least enable a predeterminable selective excitation of at least one predeterminable molecule.

In order to limit deviations of the pulse shape and the light pulses 20 from a predeterminable intended shape, provision can be made for an optional regulator apparatus 15. The light pulses 20 are supplied to the regulator apparatus 15 via a second output of the apparatus 14. By way of example, to this end, the apparatus 14 can contain a semi-transparent mirror, which subdivides the available amplitude of the light pulses according to a predeterminable ratio.

The supplied light pulses 20 are analyzed in the apparatus 14. Deviations of the pulse shape from a predeterminable intended shape are encoded into an optical and/or electric correction signal and supplied to the apparatus 14 via the line 16.

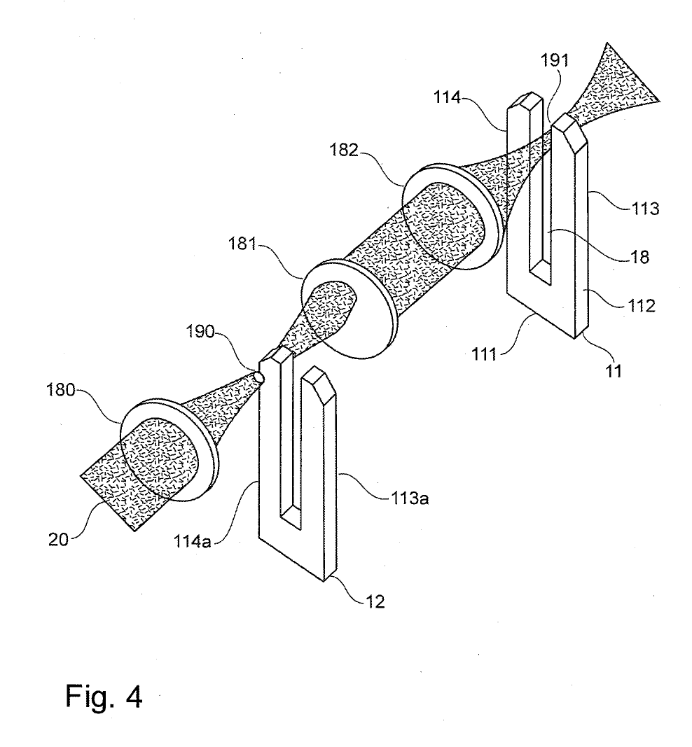

The light pulses 20 thereupon reach a modulator 12, which will be explained in more detail in conjunction with FIG. 4. The modulator 12 is designed to blank a predeterminable number of light pulses 20 such that the pulse repetition rate of the light pulses 20 downstream of the optical modulator 12 is lower than upstream of the optical modulator 12. By way of example, the pulse repetition rate downstream of the optical modulator 12 can be approximately 1 MHz, approximately 100 kHz, approximately 32 kHz, approximately 20 kHz or approximately 10 kHz. Occasionally values between the aforementioned values are also feasible. In some embodiments of the invention, the pulse repetition rate of the light pulses 20 downstream of the optical modulator 12 corresponds to the resonant frequency of the resonance body 11. In some embodiments of the invention, the optical modulator 12 can to this end comprise a resonance body that is identical to the resonance body 11 used for detection.

The resonance body 11 has a fork-shaped basic structure, as explained in more detail in conjunction with FIG. 4. In other embodiments of the invention, the resonance body 11 can also have another geometric shape, for example the shape of a cuboid or a cylinder.

In the case of a fork-shaped resonance body 11, the two elements 113 and 114 arranged approximately in parallel enclose a space 18. The molecules to be detected are situated within the space 18, for example in a gas to be analyzed and/or a gas mixture or in a fluid and/or a solution. Molecules to be detected of the gas are excited by the light pulses 20. The deexcitation of the excited molecules leads to a pressure variation in the gas or the fluid in the space 18 and, as a result of this, to a photoacoustic signal, as described in conjunction with FIG. 1. The photoacoustic signal leads to the excitation of a vibration of the resonance body 11.

To the extent that the resonance body 11 is made of piezoelectric material, the vibration of the resonance body 11 can be detected by means of an electric signal. A lock-in amplifier 17, which is connected to the optical modulator 12 in a phase-locked fashion, is available for detecting the electric signal. This makes an electric measurement signal available at the output 17a of the lock-in amplifier 17, which electric measurement signal scales with the number of molecules to be detected within the space 18.

In order to detect a plurality of different molecules within the space 18 in sequence, provision can be made in some embodiments of the invention for sequentially different pulse shapes of the light pulses 20 to be irradiated into the space 18. To this end, provision can be made for prescribing a different intended shape with the aid of the regulator apparatus 15. This makes it possible in succession to provide different pulse shapes of the light pulses 20, which in each case are suitable and intended for the optical excitation of different molecules to be detected. Since the pulse shape can change within a short period of time and only a few 100 or a few 1000 light pulses 20 are required to detect the presence and/or the amount of a specific molecule, a multiplicity of different molecules can be detected within a few seconds. The change in the pulse shape or the temporal substructure may be continuous in some embodiments of the invention, and so a predeterminable pattern of the temporal substructure and/or a temporal sequence of predeterminable patterns are run through in a set sequence.

FIG. 3 shows a further embodiment of the device 10 according to the invention. The embodiment according to FIG. 3 also contains a laser light source 13, which emits light pulses 21 with a duration of less than 200 fs, as described in conjunction with FIG. 2. The light pulses 21 are likewise shaped by means of an apparatus 14 in order thus to provide light pulses 20 with a predeterminable intended shape. Deviations from this intended shape can be corrected by means of a regulator apparatus 15. The light pulses 20 are blanked by means of an optical modulator 12, as described in conjunction with FIG. 2.

The light pulses reach a surface 30 of a solid body downstream of the optical modulator 12. Molecules to be detected can be adsorbed on the surface 30. In other embodiments of the invention, it is also possible to make the constituents of the solid body itself accessible to the spectroscopic detection.

The molecules to be detected are excited by the light pulses 20, as described in conjunction with FIG. 1. In the process, light 22 is emitted with a specific wavelength. The light 22 is guided onto the resonance body 11, which acts as a photon impulse detector, by means of an optical system 19. The signal evaluation can then, as illustrated in conjunction with FIG. 2, be brought about by means of a lock-in amplifier (not illustrated in FIG. 3).

The optical system 19 can be a collimating optical system or a focusing optical system. The optical system 19 can contain at least one optical lens. The optical system 19 can furthermore contain at least one stop. The resonance body 11 can be arranged at a predeterminable point within the half-space delimited by the surface 30. In some embodiments of the invention, the resonance body 11 is situated in the vicinity of the components 12, 13, 14 and/or 15 in order thus to enable an installation within a common housing.

In any embodiment illustrated in FIGS. 2 and 3, the light pulses 21 and the light pulses 20 can be routed as a free beam or in an optical fiber. The optical paths can also be configured partly as a free beam and partly in an optical fiber.

FIG. 4 explains the functionality of the optical modulator 12 and the resonance body 11 that is used for detecting the photoacoustic signal. The resonance body 11 contains at least two elements 113 and 114 arranged approximately in parallel. Each of the two elements 113 and 114 is fixed to a connection element 111 at a foot point 112. The end opposite to the foot point 112 projects freely. The at least two elements 113 and 114 arranged approximately in parallel can thus vibrate. Here, the vibrations can be in phase or in opposite phase. To the extent that the resonance body 11 is made of piezoelectric material, only the opposite phase vibration of the elements 113 and 114 leads to a piezoelectric signal. This makes it possible to suppress air sound incident on the device, the former leading to in-phase vibration of the elements 113 and 114 as a result of its longer wavelength.

In some embodiments of the invention, the optical modulator 12 can have an identical design to the resonance body 11. As a result, the optical modulator has the same resonant frequency as the resonance body 11. As a result, the optical modulator 12 can blank the beam of light pulses 20 with the resonant frequency of the resonance body 11.

In some embodiments of the invention, the beam guide can provide at least one optical element 180 in order to produce an intermediate focus 190 which is focused on one of the elements 113a or 114a, arranged approximately in parallel, of the optical modulator 12. Incident light is thus absorbed and/or reflected by the optical modulator 12. No light arrives in the space 18 of the resonance body 11 as a result of this. To the extent that the optical modulator 12 vibrates at its resonant frequency, the two elements 113a and 114a, arranged approximately in parallel, move cyclically, as a result of which the beam 20 in the intermediate focus 190 is released cyclically. A second focus 191 is produced by further optical elements 181 and 182, the former lying inside the space 18 of the resonance body 11. This allows the cyclical excitation of molecules to be detected inside the space 18. Hence, the photoacoustic signal generated by these molecules is generated at the resonant frequency of the resonance body 11, which leads to an effective vibration-excitation of the two elements 113 and 114 of the resonance body 11.

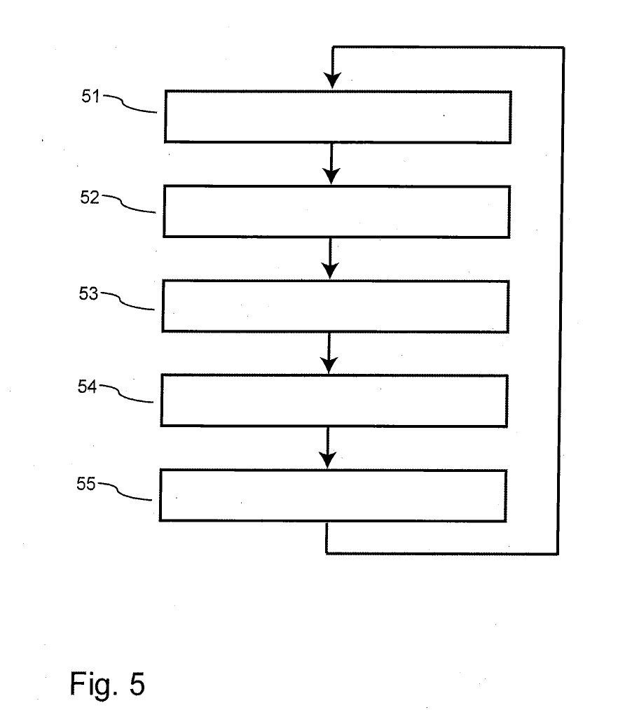

FIG. 5 shows a flowchart of an exemplary embodiment of the method proposed according to the invention.

A predeterminable pulse shape, which is suitable for spectroscopic detection of a predeterminable molecule, is set in a first method step 51. This pulse shape is then supplied to an apparatus for pulse shaping.

A plurality of light pulses with a duration of less than 200 fs and the pulse shape selected in the preceding method step are generated in the second method step 52.

In the third method step 53, the light pulses generated in the preceding method step are guided to a predeterminable point at which the molecules to be detected are situated. This leads to an interaction between the light pulses and the molecules to be detected.

To the extent that the molecules to be detected are present in a concentration above the detection level, a vibration is generated in a resonance body 11 in the fourth method step 54. Here, the vibration in the resonance body 11 can be generated either by the photon impulse of the light 22 emitted by the molecules to be detected or photoacoustically by direct mechanical action of the molecules on the resonance body 11.

The vibration of the resonance body 11 is captured in the fifth method step 55. Capturing the vibration can comprise determining the frequency and/or amplitude. The vibration can be captured by capturing an electric signal, for example a signal generated in a piezoelectric fashion. In another embodiment of the invention, the vibration can be captured by evaluating an optical signal, e.g. by means of an interferometer, by means of a location measurement, a runtime measurement of an optical signal or by measuring a Doppler shift.

To the extent that further molecules, which differ from the first detected molecules, should by detected and/or the identical molecule should be detected by means of a further excitation, the first method step is once again carried out after the fifth method step is completed. After a new pulse shape has been selected in the first method step 51, which shape permits the detection of another molecule to be detected or the excitation of another excited state of the same molecule, the method proceeds cyclically until all spectroscopic detections have been carried out. In some embodiments, the first pulse shape can be selected again thereafter such that the detection of a plurality of molecules is repeated cyclically.

The device according to the invention and the method according to the invention are particularly suitable for spectroscopic detection of trace gases in a gas atmosphere. Furthermore, the method proposed according to the invention and the device proposed according to the invention can be used to detect blasting agents and/or explosive materials in the gas phase or as a solid.

It is self-evident that the illustrated exemplary embodiments can be varied in order thus to obtain further, different embodiments of the invention. The description above should therefore not be construed as restrictive, but rather be considered explanatory. The claims below should be understood such that a mentioned feature is present in at least one embodiment of the invention. This does not preclude the presence of further features. To the extent that the claims define “first” and “second” features, this designation serves to distinguish between two identical features, without setting an order.

1.-20. (canceled)

21. Device for spectroscopic detection of molecules, said device comprising
a resonance body,
an apparatus for identifying a vibration of the resonance body and
at least one laser light source being adapted to produce a laser light being shaped to pulses with a duration of less than 200 fs, said laser light being intended to interact with the molecules to be detected
an apparatus for pulse shaping of the laser light pulses by modulating the amplitude and/or the phase, and said apparatus for pulse shaping being adapted to sequentially generate different pulse shapes.

22. Device according to claim 21, comprising further a control apparatus being adapted to correct a deviation of the actual shape of the light pulses from a predeterminable shape.

23. Device according to claim 21, comprising further an optical modulator.

24. Device according to claim 23, wherein the optical modulator and the resonance body have an identical resonant frequency.

25. Device according to claim 23, wherein the optical modulator and/or the resonance body are made of a piezoelectric material.

26. Device according to claim 21, wherein the resonance body comprises at least two elongated prongs having a first end and an opposing second end, wherein the elongated prongs are arranged approximately in parallel to each other and are respectively fixed with their first ends to a connection element, wherein the second ends project freely.

27. Device according to claim 21, wherein a volume being intended to hold the molecules to be detected is at least partly delimited by the resonance body.

28. Device according to claim 26, wherein a volume being intended to hold gas molecules to be detected is at least partly delimited between the at least two elongated prongs.

29. Device according to claim 21, comprising further an optical system being adapted to focus on the resonance body the light emerging from the interaction between the laser light and the molecules to be detected.

30. Device for spectroscopic detection of molecules, said device comprising
a resonance body,
an apparatus for identifying a vibration of the resonance body and
at least one laser light source being adapted to produce a laser light being shaped to pulses with a duration of less than 200 fs, said laser light being intended to interact with the molecules to be detected
an apparatus for pulse shaping of the laser light pulses by modulating the amplitude and/or the phase, and said apparatus for pulse shaping being adapted to sequentially generate different pulse shapes
an optical modulator being adapted to blank the light pulses with a frequency corresponding to the resonance frequency of the resonance body.

31. Device according to claim 30, wherein the resonance body and/or the optical modulator comprises at least two elongated prongs having a first end and an opposing second end, wherein the elongated prongs are arranged approximately in parallel to each other and are respectively fixed with their first ends to a connection element, wherein the second ends project freely.

32. Device according to claim 30, wherein a volume being intended to hold the molecules to be detected is at least partly delimited by the resonance body.

33. Device according to claim 30, comprising further a control apparatus being adapted to correct a deviation of the actual shape of the light pulses from a predeterminable shape

34. A method for spectroscopic detection of molecules, said method comprising the following steps:
Generating light pulses with a duration of less than 200 fs and a predeterminable pulse shape,
Allowing the light pulses to interact with the molecules to be detected,
Allowing the molecules to be detected to interact with the resonance body, thereby causing a vibration of the resonance body,
Detecting the vibration of the resonance body, and
Repeating the aforementioned steps sequentially, thereby generating different pulse shapes of the light pulses.

35. Method according to claim 34, wherein the predeterminable pulse shape of the light pulses with a duration of less than 200 fs is generated by modulating the amplitude and/or the phase.

36. Method according to claim 34, wherein the actual shape of the light pulses is adjusted to an intended shape by means of a control device.

37. Method according to claim 34, wherein the light pulses are blanked with a frequency corresponding to the resonance frequency of the resonance body.

38. Method according to claim 34, wherein the resonance body at least partly delimits a volume being intended to hold the molecules to be detected and wherein the molecules to be detected are introduced into this volume in gaseous form.

39. Method according to claim 34, wherein light emerging from the interaction between the laser light and the molecules to be detected is focused on the resonance body.

40. Method according to claim 39, wherein the molecules to be detected are concealed behind a wrapping and
in a first method step an opening is formed into the wrapping by means of a first multiplicity of light pulses with a duration of less than 200 fs and a first pulse shape, and
in a second method step at least one second multiplicity of light pulses with a predeterminable second pulse shape interacts with the molecules to be detected, for the spectroscopic detection of said molecules.

41. Method according to claim 34, wherein the vibration of the resonance body is detected by means of a lock-in amplifier.

42. Method according to claim 34, wherein a blasting agent and/or explosive material is detected.
